(19) United States
(12) Patent Application Publication
(10) Pub. No.: US 2006/0216127 A1
(43) Pub. Date: Sep. 28, 2006

(54) Load assist block

(76) Inventors: Val Broadhead, Santaquin, UT (US); James D. Ludlow, Spanish Fork, UT (US)

Correspondence Address: Val Broadhead, 69 East 100 North, Santaquin, UT, 84655, US

(21) Appl. No.: 11/090,620

(22) Filed: Mar. 26, 2005

(51) Int. Cl. B60P 1/64

(52) U.S. Cl. 410/90

(57) ABSTRACT

A system for securing uneven, irregular loads of material wherein the system comprises individual units, or blocks, that may be used to compliment, or fill in, uneven spaces in an uneven load of materials. The individual units, or blocks, may have various shapes and sizes in order to help compliment uneven, irregular spaces as efficiently as possible. The individual units may also vary in density, which density will be approximately between fifteen (15) and seventy-five (75) pounds per square inch. The individual units may also be structured to allow the individual units to inter-lock with each other, thereby preventing the individual units from slipping or becoming loose during transport. Once the uneven, irregular load has been complimented, or filled in, with the individual units, the load may be secured for transport using chains or other suitable securing mechanisms.

### BACKGROUND

1. The Field of the Invention

The present invention relates to a system that may be utilized to compliment, or fill in, uneven loads of materials that are to be transported and need to be properly secured. The system may have numerous components, including without limitation, individual units, or blocks, capable of filling in uneven spaces in a load of materials.

2. Brief Description of the Art

Transport of various materials on our nation's highways occurs every day. The transport of these materials is carried out in the safest, and most efficient manner possible. The federal government has provided guidelines to help ensure that all types of materials are transported in as safe a manner as reasonably possible.

The federal government has provided specific guidelines or statutes for the transport of uneven loads of materials. These guidelines include instructions specific to weight, and instructions specific to tie downs. These guidelines are also being strictly enforced. Failure to comply with these statutes may result in the impounding of loads violating the statutes, and eventually the constructive closing of transportation businesses.

Generally, devices have been developed that may be used to secure loads of symmetrical, or even, loads of materials. These types of loads or materials may include, without limitation, wood, steel girders, and pipes.

The devices used may include brace-like units, used to provide a uniform surface where a chain, cable, or other securing means, may be used to secure the load. These brace-like units may be used to facilitate uniform spacing and loading with a certain number of individual load materials.

For example, and not by way of limitation, semi-circular braces may be used to load and stack pipes in a uniform manner, and allow the pipes to be secured to a truck bed. Another example would include square braces, or braces that provide a right angle and may be placed on the corners of wood loaded and stacked in a uniform manner, thereby providing a surface that protects the wood and facilitates securing the load of wood.

Relatively recent statutes mandate that all loads carried on interstates and highways be secured in a manner that allows chains, cables or some other securing means to rest directly on the individual surfaces of a given load. This requirement is not difficult to satisfy when working with loads of a uniform shape. This requirement may be practically impossible when working with loads that are not of a uniform shape.

The following invention provides means and a system capable of supplementing or complimenting any individual load in a manner that results in a load of uniform shape, thereby making it much easier to secure the load and comply with current transportation regulations. This system becomes very important for those manufacturers and delivery companies that work with irregular loads on a consistent basis. Without such a system, loads that do not comply with the transportation regulations may be stopped, and even impounded, until the load can be brought into compliance. This may effectively shut down the transportation services of a company.

### SUMMARY OF THE INVENTION

The current invention is wonderfully simple. An individual unit, or block, is used to fill the gap space in any load of materials. The individual unit is made of a durable, semi-flexible material that can withstand use in the numerous environments that may be encountered on interstates and highways. The individual units may be inter-locking, or able to be stacked in such a manner that the resulting individual units will form one continuous, non-moving mass.

The individual units may be of a consistent size and shape, such as substantially square blocks. The individual units may also be of differing sizes and shapes, thereby allowing a wider range of gap spaces to be filled in the most efficient manner possible.

The individual units are stacked in the gap space of any load so the resulting load has a uniform shape. The uniform shape of the resulting load will facilitate the securing and transportation of the load, and make sure the load complies with applicable statutes.

The fact that this invention will be readily available and easy to use may very well lead to this invention being designated as the industry standard for securing and transporting irregularly shaped loads. Currently, the majority of transportation companies use a wide variety of materials to fill any gap space in an irregular load, including without limitation, cardboard, old tires, and pieces of carpet. These materials are not particularly useful because they do not remain secure during transportation, and because they are not very durable, do not allow prolonged, repeated use.

### BRIEF DESCRIPTION OF THE DRAWINGS

FIG. 1 is a perspective view of an individual unit utilizing a groove-and-tongue configuration.

FIG. 2 is a perspective view of the top of an individual unit utilizing a peg-and-hole configuration of inter-locking individual units.

FIG. 3 is a perspective view of the bottom of an individual unit utilizing the peg-and-hole configuration of inter-locking individual units.

FIG. 4 is a front view of an irregular load showing the gap space and how the load may be secured.

### DETAILED DESCRIPTION OF THE PREFERRED EMBODIMENTS

It will be readily understood that the following detailed description of the embodiments of the individual units 10, and the steps for using the individual units 10, is not intended to limit the scope of the invention, as claimed, but is merely representative of the presently preferred embodiments of the invention.

1. Structure of the Individual Unit

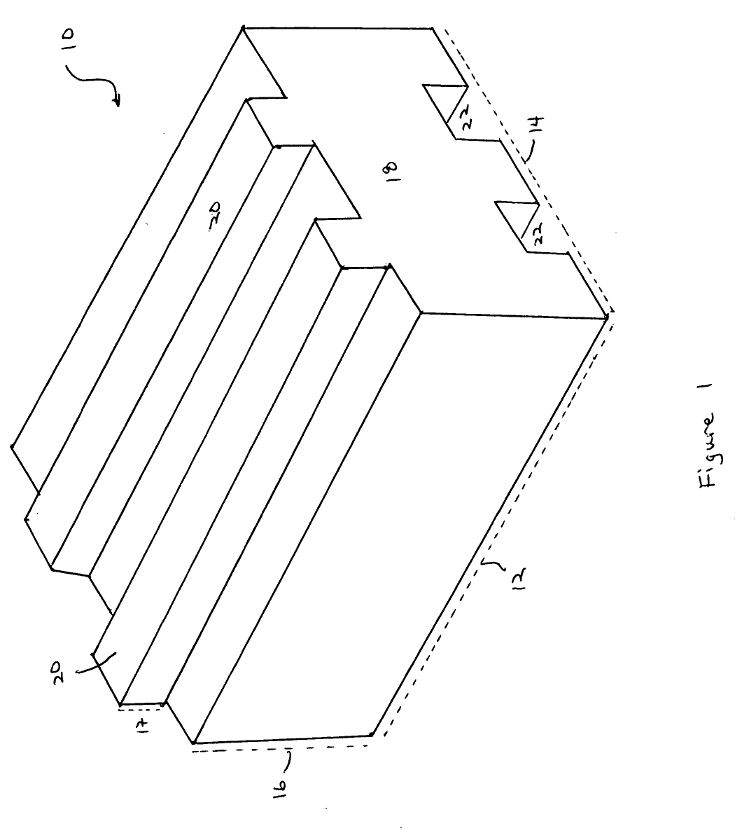

The structure of the individual unit 10 is very simple. The individual unit 10 may also be described as the individual means for complimenting an irregular load 38. As shown in FIG. 1, individual unit 10 has a length 12, width 14, and height 16. Generally, the size of each individual unit 10 will be approximately uniform. The length 12, width 14, and height 16 of the individual units 10 will not vary in relation to corresponding individual units 10. The length 12 of an individual unit 10 may be between approximately six (6) inches and thirty-six (36) inches. The width 14 of an individual unit 10 may be between approximately four (4) inches and eighteen (18) inches. The height 16 of an individual unit 10 may be between approximately three (3) inches and eighteen (18) inches. Preferably, the length 12 may be approximately ten (10) inches, the width 14 may be approximately eight (8) inches, and the height 16 may be approximately four (4) inches. However, those skilled in the art will recognize that the individual units 10 may have varying sizes. Varying sizes may allow the individual units 10 to be used in a wider array of irregular loads 38.

The individual unit 10 may come in a variety of shapes. An individual unit 10 will need to have a certain amount of length 10 to be effective. However, the face surface 18, or cross-section providing some width 14 and height 16, of an individual unit 10 may come in a variety of shapes. The variety of shapes of the face surface 18 may include, without limitation, a rectangle, square, circle, or triangle.

The individual unit 10 may be composed of a wide variety of materials, including without limitation, styrofoam, foam rubber, hardened rubber, and various plastics such as polyurethane or polyethylene. The density of the individual unit 10 needs to be high enough that the individual unit 10 will be durable, yet flexible enough that the individual unit 10 will conform to the desired shape. The individual unit 10 may have a density between approximately fifteen (15) pounds per square foot and seventy-five (75) pounds per square foot, and preferably approximately forty-five (45) pounds per square foot.

The individual unit 10 may also be made of a material that does not promote slippage, or shifting during transportation. Another feature preventing slippage of the individual units 10 during transportation includes using some sort of interlocking means to temporarily connect the individual units 10. For example and not by way of limitation, the inter-locking means, or interlocking mechanism, may be described as tongue-and-groove, or peg-and-hole.

As shown in FIG. 1, the tongue-and-groove inter-locking means includes at least one tongue 20, or ridge, that traverses longitudinally across the top surface of an individual unit 10. Corresponding grooves 22 are located in the bottom surface of an individual unit 10. The tongues 20 will have a protuberance height 17 between approximately one-quarter (¼) inch and four (4) inches, and preferably approximately one-half (½) inch. The grooves 22 will have a depth corresponding to the protuberance height 17. When the individual units 10 utilizing a tongue-and-groove configuration are stacked, the tongue 20 of one individual unit 10 will inter-lock, or fit inside, the groove 22 of an individual unit 10 directly above the first individual unit 10.

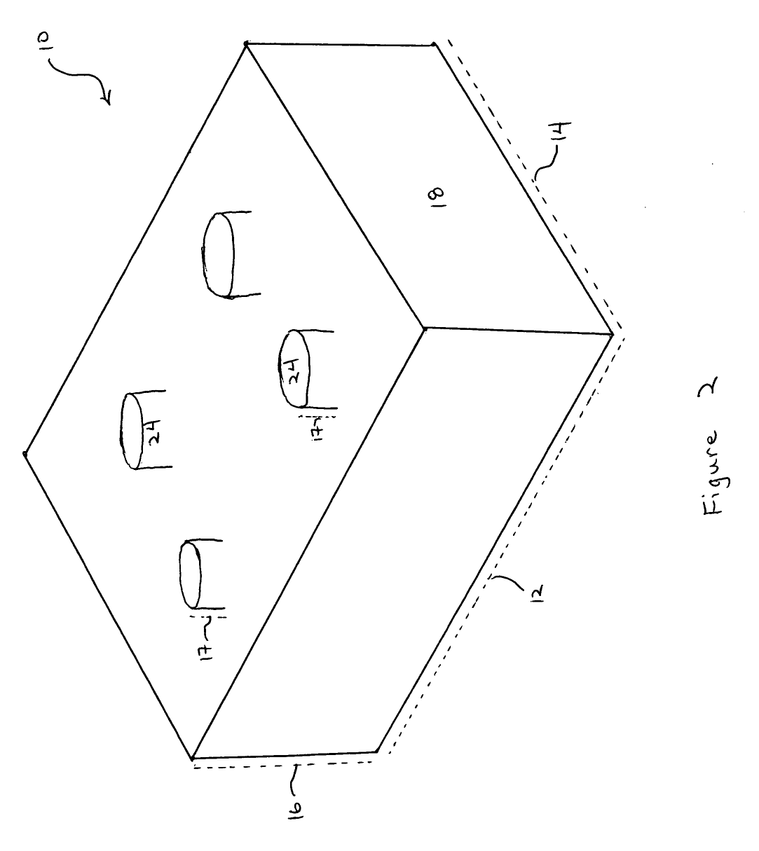

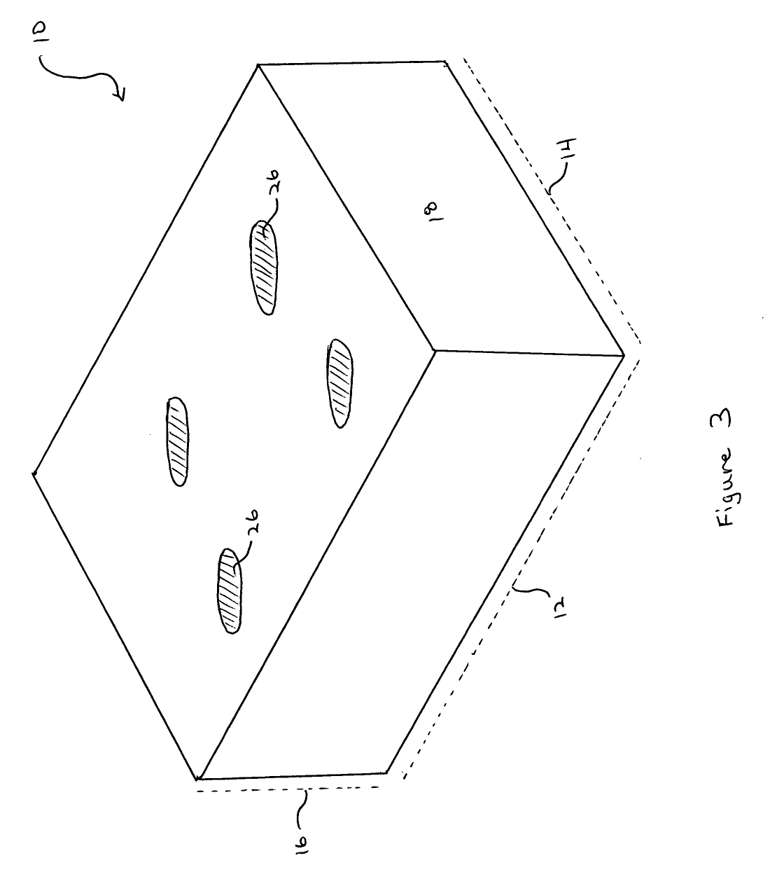

As shown in FIG. 2, the peg-and-hole inter-locking means includes at least one peg 24, or protrusion, located on the top surface of an individual unit 10. As shown in FIG. 3, corresponding holes 26, or depressions, are located in the bottom surface of an individual unit 10. The pegs 24 will have a protuberance height 17 between approximately one-quarter (¼) inch and four (4) inches, and preferably approximately one-half (½) inch. The holes 26 will have a depth corresponding to the protuberance height 17. When the individual units 10 utilizing a peg-and-hole configuration are stacked, the peg 24 of one individual unit 10 will inter-lock, or fit inside, the hole 26 of an individual unit 10 directly above the first individual unit 10.

As will be recognized by those skilled in the art, some varying shapes of an individual unit 10 may not allow for the use of an inter-locking means, however, the shape of the individual unit 10 may make the use of an inter-locking means unnecessary.

3. Use of the Individual Units

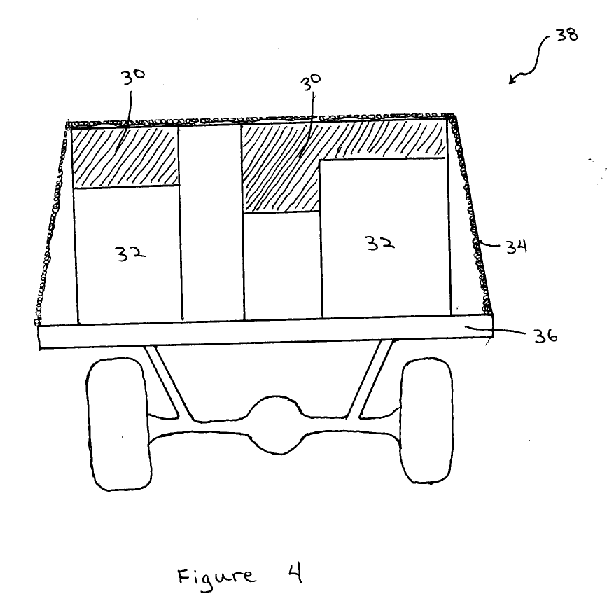

FIG. 4 is intended to illustrate use of the individual units 10. The truck bed 36 has certain materials loaded onto it. The components 32 of the load may be different sizes and shapes, resulting in gap space 30, and an overall irregular load 38.

The gap space 30 may be filled with individual units 10, resulting in a more uniform load. This process may be described as complimenting the irregular load 38. The complimented, or uniformly shaped, load may now be more easily secured with chains 34, cables, or other securing mechanisms. The resulting load is also more easily made to comply with applicable statutes.

What is claimed and desired to be secured by United States Letters Patent is:

1. A load securing system comprising:
an individual unit;
said individual unit has an interlocking mechanism;
said individual unit having a density between fifteen (15) and seventy-five (75) pounds per square foot; and
said individual unit used to compliment an irregular load.

2. A load securing system as in claim 1 wherein said individual unit has a length of approximately ten (10) inches, a width of approximately eight (8) inches, and a height of approximately four (4) inches.

3. A load securing system as in claim 1 wherein said individual unit has a density between forty (40) and fifty (50) pounds per square foot.

4. A load securing system as in claim 1 wherein said interlocking mechanism of said individual unit comprises at least one tongue and at least one corresponding groove.

5. A load securing system as in claim 1 wherein said interlocking mechanism of said individual unit comprises at least one peg and at least one corresponding hole.

6. A load securing system as in claim 1 wherein said individual unit has a triangular face surface.

7. A load securing system as in claim 1 wherein said individual unit has a square face surface.

8. A load securing system as in claim 1 wherein said individual unit has a circular face surface.

9. A load securing system comprising:
individual means for complimenting an irregular load; and
means for interlocking said individual means for complimenting an irregular load.

10. A load securing system as in claim 9 wherein said individual means for complimenting an irregular load has a length of approximately ten (10) inches, a width of approximately eight (8) inches, and a height of approximately four (4) inches.

11. A load securing system as in claim 9 wherein said individual means for complimenting an irregular load has a density between forty (40) and fifty (50) pounds per square foot.

12. A load securing system as in claim 9 wherein said means for interlocking said individual means for complimenting an irregular load is comprised of at least one tongue and at least one corresponding groove.

13. A load securing system as in claim 9 wherein said means for interlocking said individual means for complimenting an irregular load is comprised of at least one peg and at least one corresponding hole.

14. A load securing system as in claim 9 wherein said individual means for complimenting an irregular load has a triangular face surface.

15. A load securing system as in claim 9 wherein said individual means for complimenting an irregular load has a square face surface.

16. A load securing system as in claim 9 wherein said individual means for complimenting an irregular load has a circular face surface.

17. A method for securing an uneven load comprising:
providing an individual unit;
complimenting uneven, gap spaces in an irregular load with said individual units; and
securing said irregular load.

18. The method of claim 17 further comprising:
providing said individual units having varying face surfaces; and
complimenting uneven, gap spaces in said irregular load with said individual units having varying face surfaces.

19. The method of claim 17 further comprising: securing said uneven load with chains.
